(19) United States
(12) Patent Application Publication
(10) Pub. No.: US 2004/0120106 A1
(43) Pub. Date: Jun. 24, 2004

(54) Transformable computer and system and method incorporating same

(76) Inventors: Tom J. Searby, Greeley, CO (US); Sean W. Tucker, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/324,671

(22) Filed: Dec. 20, 2002

(51) Int. Cl. G06F 1/16

(52) U.S. Cl. 361/683; 361/724

(57) ABSTRACT

A transformable computer comprises a computer chassis and a plurality of mounts. The computer chassis comprises a mounting latch member. The plurality of mounts are interchangeably coupleable with the mounting latch member, wherein the plurality of mounts comprise a rail mount for a rack mount computer configuration and a tower base mount for a vertical tower computer configuration. A method of using a computer chassis comprising providing a computer chassis and interchangeably coupling one of a rack mountable rail and a tower base mount to the computer chassis at least partially with a tool-free coupling member.

### BACKGROUND OF THE INVENTION

Over the years, computer systems have gained widespread use for a variety of stationery and mobile applications, such as industrial systems, academic institutions, professional institutions, consumer markets, government, and so forth. Unfortunately, many incompatibilities, conflicts, and differences still remain between these various computer systems. For example, computer systems in different market segments and institutions often have different form factors, operating systems, hardware configurations, assembly and mounting configurations, and other inconsistencies. In the consumer market, many differences exist between desktop computers, laptop computers, and personal digital assistants. Further differences exist between the consumer market and other markets. Consumer desktop computers have form factors and mounting structures that allow stand-alone mounting at the consumer's desk or work area. In contrast, network systems and various rack mount computer systems have form factors and mounting mechanisms, which enable rack mountable devices to be mounted horizontally in a rack structure. Regarding packaging, computers in the consumer market have casings that are functionally and cosmetically adapted for use and potential abuse by non-professional users, while network systems and various rack mount computer systems may have industrial configurations and structures adapted for use and handling by professional/technical users. It is differences such as these that perpetuate the various incompatibilities, inconsistencies, and general lack of uniformity throughout the computer industry.

### SUMMARY

According to one embodiment, a transformable computer comprises a computer chassis and a plurality of mounts. The computer chassis comprises a mounting latch member. The plurality of mounts are interchangeably coupleable with the mounting latch member, wherein the plurality of mounts comprise a rail mount for a rack mount computer configuration and a tower base mount for a vertical tower computer configuration.

In another embodiment, a system comprises a mounting latch member, a rack mount, and a tower base. The mounting latch member is adapted for positioning on a computer chassis. The rack mount is adapted to mount the computer chassis in a rack mount computer system. The tower base mount is adapted to mount the computer chassis in a vertical tower configuration. The rack and tower base mounts are interchangeably coupleable with the mounting latch member.

In a further embodiment, a computer system comprises a computer chassis and means for interchangeably transforming the computer chassis between rack mount and vertical tower configurations.

Another embodiment comprises a method of using a computer chassis comprising providing a computer chassis and interchangeably coupling one of a rack mountable rail and a tower base mount to the computer chassis at least partially with a tool-free coupling member.

### BRIEF DESCRIPTION OF THE DRAWINGS

Exemplary embodiments will hereafter be described with reference to the accompanying drawings, wherein like reference numerals denote like elements, and:

FIG. 1 is a perspective view illustrating a computer chassis in accordance with an embodiment of the present invention;

FIG. 2 is a perspective view illustrating an embodiment of a rack mounting structure coupled to the computer chassis of FIG. 1;

FIGS. 3 and 4 are close-up perspective views illustrating embodiments of front mounts coupled to the computer chassis of FIGS. 1 and 2;

FIG. 5 is a perspective view illustrating an embodiment of a rack structure used with the computer chassis illustrated in FIGS. 1 and 2;

FIG. 6 is a close-up perspective view illustrating an embodiment of a front mount interface and rail used with the rack structure illustrated in FIG. 5;

FIG. 7 is a close-up perspective view illustrating an embodiment of the computer chassis coupled to the front mount interface illustrated in FIGS. 5 and 6;

FIG. 8 is a perspective view illustrating an embodiment of a rack mount computer system using the computer chassis and corresponding mount structures illustrated in FIGS. 1-7;

FIG. 9 is a close-up perspective view illustrating embodiments of covers coupled to the rack mount computer system illustrated in FIG. 8;

FIG. 10 is a perspective view illustrating a tower base mount coupled to the computer chassis of FIG. 1 in accordance with alternative embodiment of the present invention;

FIG. 11 is a face view illustrating an embodiment of the tower base mount illustrated in FIG. 10;

FIG. 12 is a perspective view illustrating an embodiment of a tower mount computer system using the computer chassis and tower base mount illustrated in FIGS. 1 and 10;

FIG. 13 is a perspective view illustrating an embodiment of a top cover coupled to the tower mount computer system illustrated in FIG. 12;

FIG. 14 is a perspective view illustrating an embodiment of a front cover coupled to the tower mount computer system illustrated in FIGS. 12-13; and

FIG. 15 is a perspective view illustrating an embodiment of lateral support covers disposed about opposite faces of the tower mount computer system illustrated in FIGS. 12-14.

### DETAILED DESCRIPTION

As discussed in detail below, the illustrated embodiments comprise a variety of unique computer systems having a computer chassis with different mounting mechanisms, which enable the computer chassis to transform between distinctly different computer applications and environments. For example, the different mounting mechanisms may comprise rack mount structures to facilitate the integration of the computer chassis within a rack mount computer system, which may support multiple rack mountable devices. By further example, the rack mount computer system may comprise a network server, a security system, a Web server, or other desired rack mountable devices. In view of other types of computer environments and applications, the mounting mechanisms also may comprise tower mount structures to support the computer chassis as a stand-alone computer system in a vertical tower configuration. In this vertical tower configuration, the computer chassis may be configured as a personal computer, a network server, or any other suitable computer system. Other embodiments also may support a wide variety of other configurations, such as a horizontal desktop configuration.

In each of these configurations, the illustrated embodiments can transform the same computer chassis into uniquely different computer systems, thereby providing uniformity between the various computer applications and environments. Absent these transformation mechanisms (e.g., interchangeable mounting mechanisms), manufacturers may continue to develop distinctly different hardware, software, form factors, computer chassis, and other components. By adopting a more universal approach to these different computer applications and environments, economies of scale can be achieved in the research and development, production, distribution, and general advancement of computer systems.

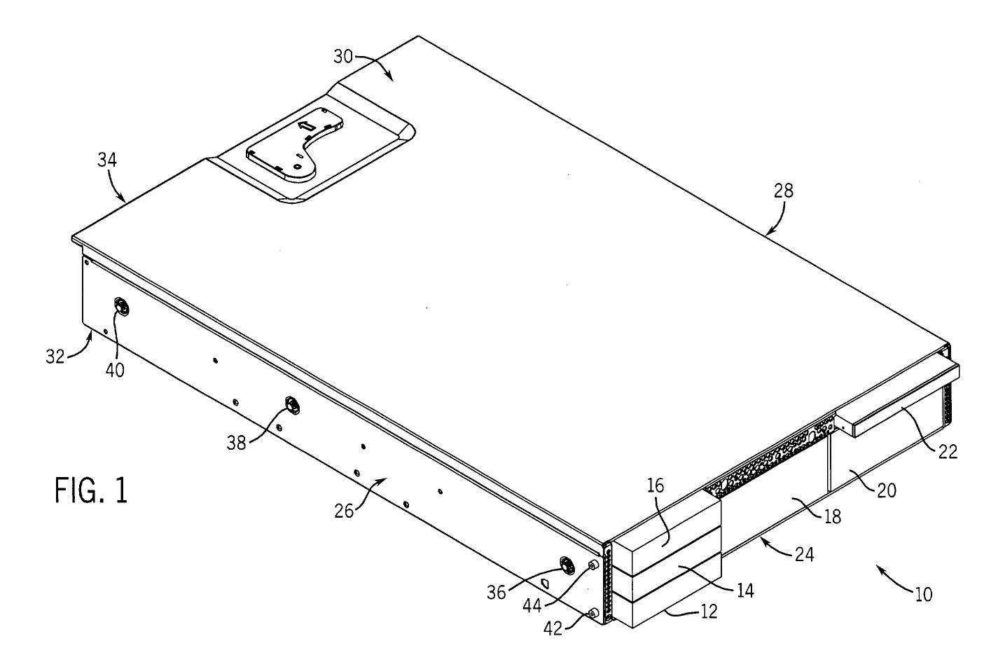

FIG. 1 is a perspective view illustrating a computer chassis 10 in accordance with certain embodiments of the disclosed subject matter. Depending on the intended use, the illustrated computer chassis 10 may comprise one or more processors, memory modules, hard disk drives, floppy disk drives, optical drives, circuit boards, communication devices (e.g., network, wireless, etc.), audio/video devices, power supplies, fans, and other desired computing components. For example, computing components 12-22 are disposed in a front 24 of the computer chassis 10. It should be noted that these computing components 12-24 may embody removable modular components, such as multiple hard drives, multiple power supplies, and one or more disk drives. However, any suitable components and configurations are within the scope of the illustrated embodiments.

Structurally, the computer chassis 10 may comprise a wide variety of forms and configurations, such as a form factor corresponding to a rack mountable device (e.g., a rack mount server). However, any suitable form or structure is within the scope of the illustrated embodiments. The illustrated computer chassis 10 has opposite sides 26 and 28, opposite faces 30 and 32 disposed about the opposite sides 26 and 28, and a rear 34 disposed opposite the front 24. On each of the opposite sides 26 and 28, the computer chassis 10 comprises a plurality of mounting latch members or coupling members, such as bossed members 36, 38, and 40. These bossed members 36, 38, and 40 may comprise any suitable attachment or mounting mechanisms within the scope of the illustrated embodiments. For example, the bossed members 36, 38, and 40 may embody male or female portions of a tool-free coupling mechanism, snap-fit members, spring-loaded latches or pins, and other suitable couplings. Alternatively, latching receptacles or keyhole slots may be substituted for the bossed members 36, 38, and 40, which may be disposed on the mating component (e.g., rails 46-48 or tower base mount 156) instead of the computer chassis 10. One or more additional coupling members, such as front mount attachment structures 42 and 44, also may be disposed on the opposite sides 26 and 28. As illustrated in detail below, the illustrated embodiments use one or more of these bossed members 36, 38, and 40 and front mount attachment structures 42 and 44 to transform the computer chassis 10 between different computer applications and environments.

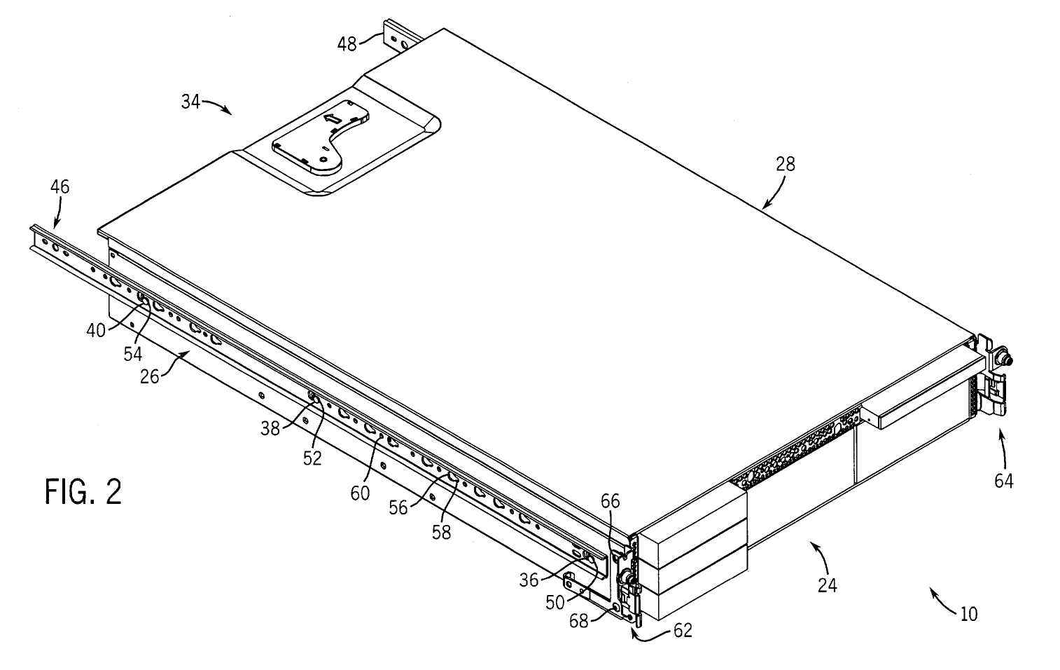

For example, the bossed members 36, 38, and 40 and front mount attachment structures 42 and 44 may be used to adapt the computer chassis 10 to a rack mount computer system, as illustrated with reference to FIGS. 2-9. FIG. 2 is a perspective view illustrating rack mounting structures or rails 46 and 48 coupled to the opposite sides 26 and 28 of the computer chassis 10 via the bossed members 36, 38, and 40 in accordance with certain embodiments of the disclosed subject matter. As illustrated, the rack mounting structures or rails 46 and 48 comprise a plurality of mounting latch members or coupling members, such as latching receptacles or keyhole slots 50, 52, and 54, which preferably are tool-lessly coupled with the bossed members 36, 38, and 40, respectively. For example, the rails 46 and 48 can be mounted to the sides 26 and 28 by aligning and engaging an enlarged portion 56 of the keyhole slots 50, 52, and 54 with an enlarged portion of the bossed members 36, 38, and 40. The rails 46 and 48 can then be interlocked with the sides 26 and 28 by sliding the keyhole slots 50, 52, and 54 along the bossed members 36, 38, and 40 into a narrowed portion 58 of the keyhole slots 50, 52, and 54. If desired, the rails 46 and 48 can be further secured to the sides 26 and 28 via a snap fit mechanism, a spring-loaded latch or pin, threaded fasteners, or other suitable couplings. For example, externally threaded fasteners 60 may be disposed through the rails 46 and 48 and into the sides 26 and 28.

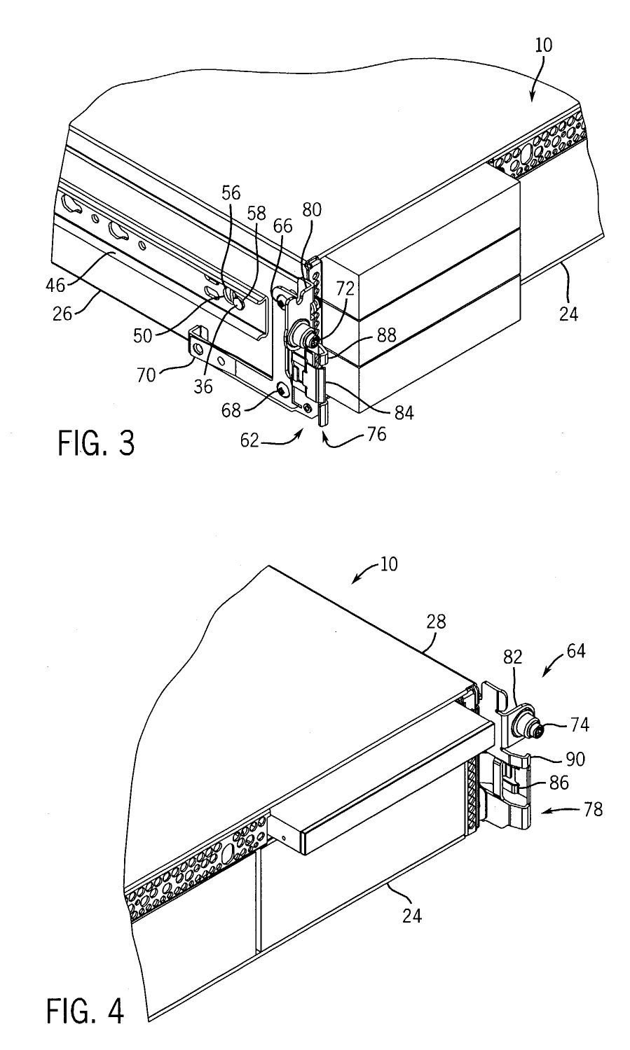

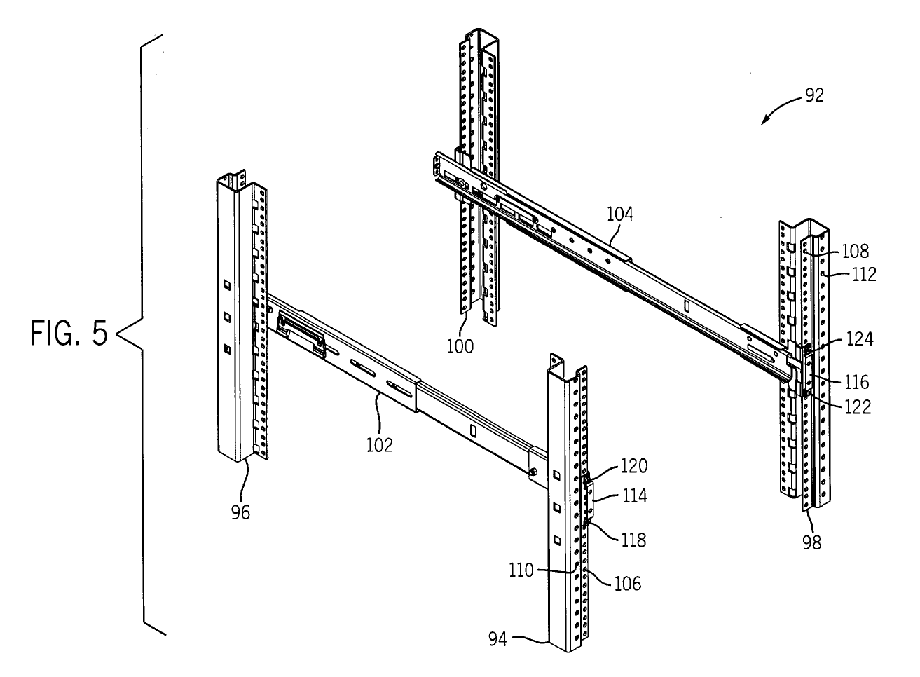

In addition to the rack mounting structures or rails 46 and 48, front mounts 62 and 64 may be coupled to opposite sides 26 and 28 of the computer chassis 10 near the front 24. As illustrated, externally threaded fasteners 66 and 68 are extended through the front mounts 62 and 64 and into the sides 26 and 28. However, any other suitable attachment or mounting mechanisms can be used to attach the front mounts 62 and 64 within the scope of the illustrated embodiments. FIGS. 3 and 4 are close-up perspective views illustrating the front mounts 62 and 64 coupled to the computer chassis 10 of FIGS. 1 and 2 in accordance with certain embodiments of the disclosed subject matter. As illustrated in FIG. 3, the front mounts 62 and 64 each comprise a lateral support member 70 extending outwardly from the opposite sides 26 and 28. For example, the lateral support member 70 may embody a spring-loaded tab or latch structure, which can be used to provide an outward holding force or latch engagement within a rack mount structure (see FIGS. 5-8). In the embodiments of FIGS. 3 and 4, the front mounts 62 and 64 also have a variety of tool-based and tool-free mounting mechanisms, such as threaded fasteners 72 and 74 and latch mechanisms 76 and 78, respectively. It should be noted that the threaded fasteners 72 and 74 may be rotatably retained within the front tab portions 80 and 82 of the front mounts 62 and 64. However, any suitable configuration or type of tool-based fasteners are within the scope of the illustrated embodiments. Regarding the latch mechanisms 76 and 78, the present embodiments may have inner latches 84 and 86 and outer latches or stops 88 and 90, respectively. Again, the inner and outer latches 84-90 of the latch mechanisms 76 and 78 may be coupled (e.g., snap-fit) with mating latch mechanisms in a rack mount structure (see FIGS. 5-8). Once mounted, these latch mechanisms 76 and 78 can be released by applying a suitable release force (e.g., depressing, laterally moving, etc.).

After incorporating the foregoing rails 46 and 48 and front mounts 62 and 64, the computer chassis 10 is generally configured as a rack mountable device for mounting to a rack structure. FIG. 5 is a perspective view illustrating a rack structure 92 in accordance with certain embodiments of the disclosed subject matter. It should be noted that the rack structure 92 may comprise a wide variety of form factors, external and internal features, casings, supports, electrical wiring, communication connectors, rack mount devices, device receptacles, and other desired components. Moreover, the structural integrity and protective outer casings (if desired) of the rack structure 92 may provide substantial protection for the rack mountable devices, thereby enabling the rack mountable devices to have relatively less structural protection and simpler support structures. Again, the degree of support and protection for both the rack structure 92 and the rack mountable devices depends largely on the intended application, environment, and so forth. In one embodiment, the rack structure 92 may be configured as a rack mount computer system having a plurality of servers, network components, and other rack mount devices.

The illustrated rack structure 92 of FIG. 5 has a plurality of legs 94-100 and a plurality of rack mounting structures, such as rails 102 and 104 extending horizontally between the legs 94-96 and legs 98-100, respectively. These rails 102 and 104 may comprise a wide variety of rail structures and configurations, linear positioning systems, automation systems and electric motors, and so forth. The rack structure 92 also can have various front mounting mechanisms, such as receptacles 106 and 108 and outer receptacles 110 and 112, extending along a front portion of the legs 94 and 98, respectively. In assembly, rack mount devices may be coupled to these inner and outer receptacles 106-112 either directly or indirectly via an interface.

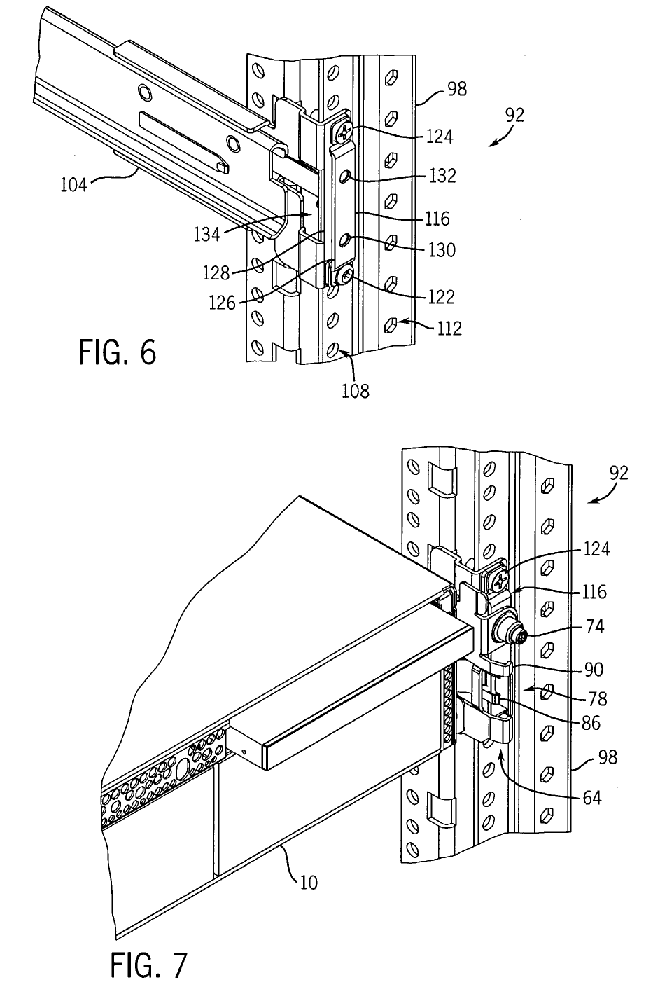

For example, the illustrated rack structure 92 comprises front mount interfaces 114 and 116 coupled to the legs 94 and 98 at inner receptacles 106 and 108 via fasteners 118-120 and 122-124 (e.g., screw, pin, etc.), respectively. However, any suitable direct or indirect front mounting mechanisms are within the scope of the illustrated embodiments. FIG. 6 is a close-up perspective view illustrating the front mount interface 116 and rail 104 coupled to the rack structure 92 of FIG. 5 in accordance with certain embodiments of the disclosed subject matter. As illustrated, the front mount interface 116 has an outer member 126 extending along the leg 98 in alignment with the inner receptacles 108. Adjacent the rail 104, the front mount interface 116 also includes an inner member 128 extending along an inner portion of the leg 98. In operation, the outer and inner members 126 and 128 facilitate the mounting of a desired rack mount device, such as the computer chassis 10 illustrated in FIGS. 2-4. It also should be noted that these outer and inner members 126 and 128 may comprise a wide variety of tool-based and tool-free coupling members, latch mechanisms, receptacles, and other interfacing structures. However, the illustrated outer member 126 has receptacles 130 and 132 disposed in a spaced-apart relationship with the inner member 128, such that a suitable tool-based or tool-free attachment member may be coupled with the front mount interface 116. An attachment receptacle or mounting slot 134 is also provided in the illustrated inner member 128, such that a mating attachment structure or latch can be engaged with the front mount interface 116. Although not illustrated in FIG. 6, the front mount interface 114 also may have one or more of the foregoing inner and outer members 126 and 128 and corresponding mounting features.

Accordingly, a desired rack mount device, such as the computer chassis 10 illustrated in FIGS. 2-4, may be mounted to the rack structure 92 via the rails 102 and 104 and the front mount interfaces 114 and 116. FIG. 7 is a close-up perspective view illustrating the computer chassis 10 and corresponding front mount 64 of FIGS. 2 and 4 coupled to the front mount interface 116 of FIGS. 5 and 6 in accordance with certain embodiments of the disclosed subject matter. As illustrated, the computer chassis 10 and corresponding front mount 64 are mounted to leg 98 of the rail structure 92 via engagement of the threaded fastener 74 and latch mechanism 78 with the receptacle 132 and mounting slot 132, respectively. For example, the threaded fastener 74 may comprise external threads, while the receptacle 132 or a separate fastener disposed behind the outer member 126 has internal threads. It should be noted that the threaded fastener 74 has an oversized graspable head, which facilitates hand-tightening and removal. Accordingly, the threaded fastener 74 may be secured and released from the receptacle 132 without using any tool. Alternatively, the fastener 74 may embody a snap-fit mechanism, a spring-loaded pin or latch, or another suitable tool-based or tool-free coupling mechanism. Regarding the latch mechanism 78, the inner latch 86 may be snap-fitted or releasably disposed in the mounting slot 134, while the outer latch or stop 90 may be disposed about the outer member 126 in a retaining manner. Again, although not illustrated in FIG. 7, the front mount 62 and front mount interface 114 also may be mounted together by one or more of the foregoing tool-based or tool-free mounting mechanisms. Accordingly, the illustrated computer chassis 10 is releasably coupled to the rack structure 92 at the front 24, where a user can easily and tool-lessly insert and release the computer chassis 10 for sliding movement along the rails.

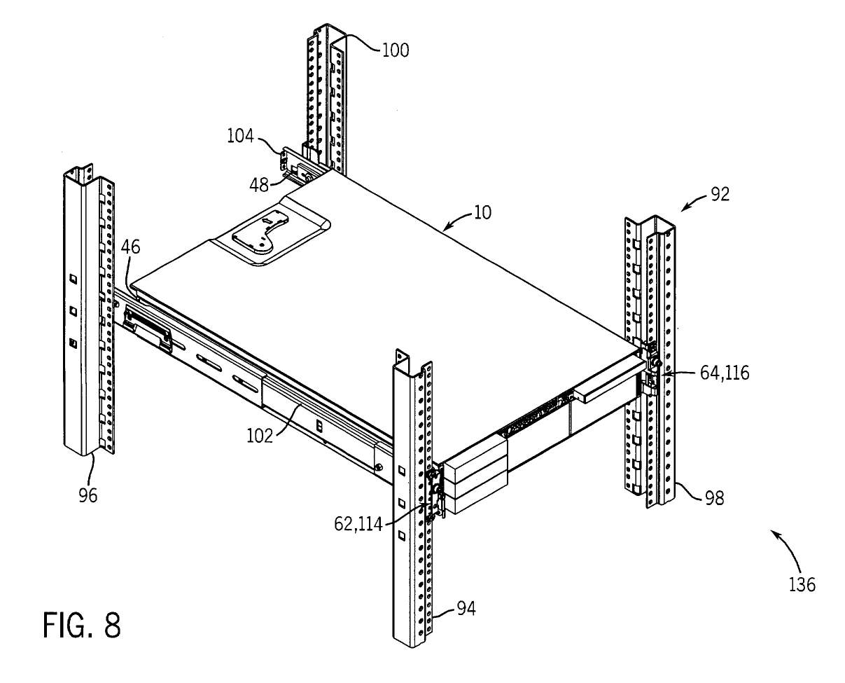

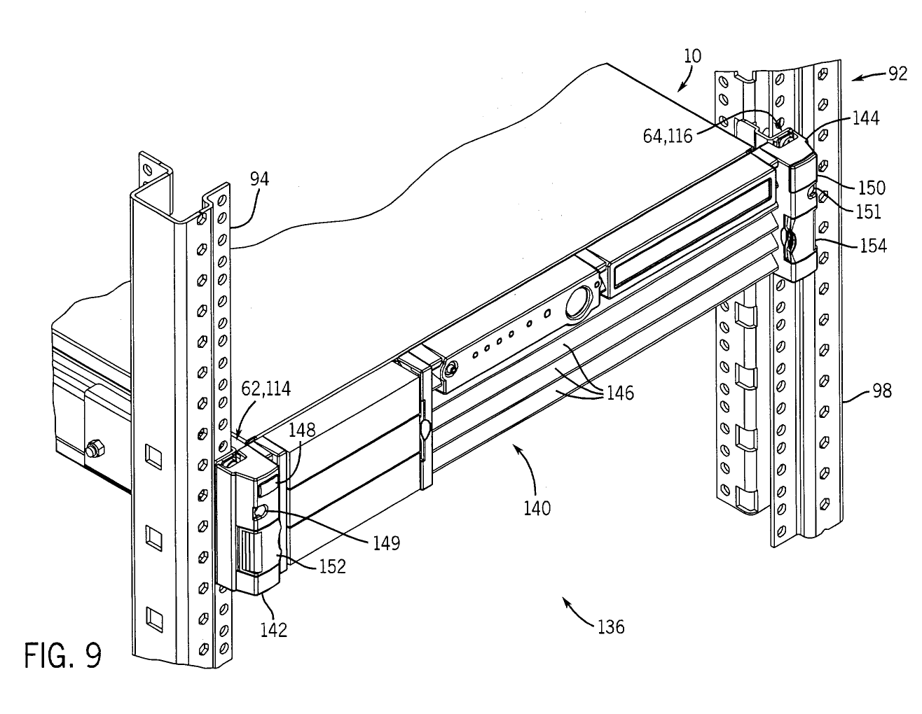

FIG. 8 is a perspective view illustrating a rack mount computer system 136 having the computer chassis 10 and corresponding mount structures of FIGS. 1-4 and 6-7 coupled to the rack structure of FIG. 5. As illustrated, the computer chassis 10 is mounted to the rail structure 92 via engagement of the rails 46-48 with rails 102-104 and engagement of front mounts 62-64 with front mount interfaces 114-116, respectively. As noted above, the illustrated rack mount computer system 136 may comprise a wide variety of form factors, external and internal features, casings, supports, electrical wiring, communication connectors, rack mount devices, device receptacles, and other desired components. For example, a front cover 140 and front mount covers 142 and 144 may be coupled to the front 24 of the computer chassis 10 and corresponding front mounts 62 and 64 of the rack mount computer system 136, as illustrated in the embodiment of FIG. 9. Although these covers 140-144 may have certain cosmetic features, they also have unique functional aspects that complement or interact with features of the computer chassis 10 and the front mounts 62 and 64. For example, the front cover 140 may include vent openings 146, which can channel airflow through/from internal fans and power supplies. Additionally, the front mount covers 142 and 144 may include fastener covers 148 and 150 and latch release actuators 152 and 154, which can interact with the latch mechanisms 76 and 78 of the front mounts 62 and 64, respectively. Receptacles 149 and 151 also may be provided for access to fasteners, such as threaded fasteners, disposed behind the fastener covers 148 and 150. Other functional casings or covers are also within the scope of the illustrated embodiments. Moreover, the rack mount computer system 136 of the illustrated embodiments may be configured as a central computing system for a corporation, an academic institution, a government facility, an Internet-based company, or any other suitable application and environment.

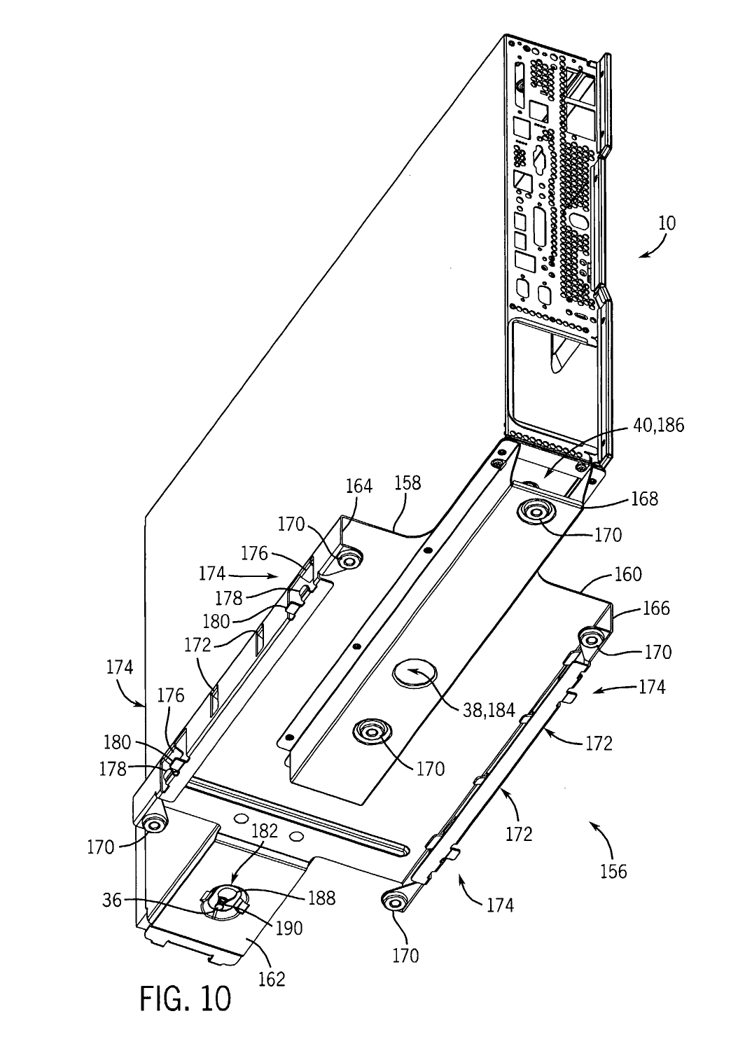

Turning now to FIGS. 10-15, an alternative embodiment of the computer chassis 10 is illustrated in light of the following description. FIG. 10 is a perspective view illustrating a tower base mount 156 coupled to the computer chassis 10 of FIG. 1 in accordance with certain embodiments of the disclosed subject matter. As discussed above, the illustrated computer chassis 10 may comprise a wide variety of forms and structures, such as a form factor corresponding to a rack mountable device (e.g., a rack mount server). However, any suitable form or structure is within the scope of the illustrated embodiments. As illustrated, the tower base mount 156 comprises lateral support sections 158 and 160 extending outwardly from a central base section 162. Depending on the form factor and weight distribution of the computer chassis 10, the tower base mount 156 may comprise a wide variety of support structures or struts to provide additional lateral support and/or flexibility to mount the computer chassis 10 reliably in a vertical tower mount configuration. For example, the lateral support sections 158 and 160 may have outer strut members 164 and 166, while the central base section 162 may have a channel support structure 168. Moreover, a plurality of surface support members or feet 170, such as rubber feet, can be coupled to various inner and outer portions of the tower base mount 156.

If one or more cosmetic and/or functional casings or additional support structure are desired, then the tower base 156 also may include a wide variety of tool-based and tool-free attachment mechanisms, such as snap-fit or spring-loaded latches. For example, in the illustrated embodiment, the lateral support sections 158 and 160 comprise lateral slots 172 and lateral receptacles 174. Each of these slots 172 and receptacles 174 may have additional attachment structures or mechanisms that enable external casings or structures to be mounted to the tower base mount 156. For example, the lateral receptacles 174 may have inward tabs 176, upward tabs 178, and lateral tabs 180. Accordingly, the computer chassis 10 and corresponding tower base mount 156 can be encased and further supported (if desired) for use in a wide variety of stand-alone vertically-mounted configurations, such as home or office computing environments. It should be noted that these attachment mechanisms (e.g., slots 172 and receptacles 174) and additional outer casings are particularly useful for applications having high user interaction and potential for physical abuse, such as public access computers.

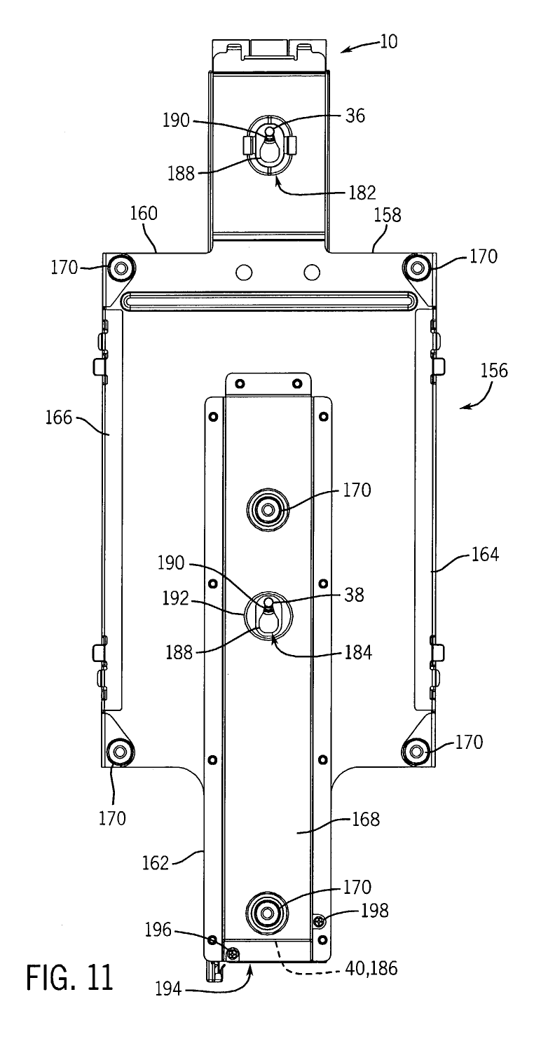

Similar to the mounting techniques illustrated in the embodiments of FIGS. 1-9, the tower base mount 156 of FIG. 10 may be mounted to one or more of the chassis' mounting latch members or coupling members, e.g., bossed members 36, 38, and 40. As illustrated in FIGS. 10 and 11, the tower base mount 156 has a plurality of mount mechanisms or mating latch members, such as keyhole slots 182, 184, and 186, which may be releasably coupled with the bossed members 36, and 38, and 40, respectively. Again, similar to the rails 46 and 48, each of the keyhole slots 182, 184, and 186 have enlarged portions 188 and narrowed portions 190. In assembly, the enlarged head portion of the bossed members 36, 38, and 40 is releasably retained within the narrowed slot portion 190 of the keyhole slots 182, 184, and 186, respectively. For example, the tower base mount 156 can be mounted to either side 26 or 28 of the computer chassis 10 by aligning and engaging the enlarged portion 188 of the keyhole slots 182, 184, and 186 with the bossed members 36, 38, and 40. If desired, the alignment process can be aided by viewing the keyhole slot 184 and the desired bossed member 38 through a view-hole or access-receptacle 192 disposed in the channel support structure 168 of the tower base mount 156. Similarly, the keyhole slot 186 and the desired bossed member 40 may be viewed through an open end portion 194 of the channel support structure 168. Once aligned and engaged, the tower base mount 156 can be interlocked with the computer chassis 10 by sliding the keyhole slots 182, 184, and 186 along the bossed members 36, 38, and 40 into the narrowed portion 190 of the keyhole slots 182,184, and 186. At this position, the retention of the bossed members 36, 38, and 40 within the narrowed slot portion 190 of the keyhole slots 182, 184, and 186 prevents any vertical or outward separation of the computer chassis 10 from the tower base mount 156.

Lateral retention within the keyhole slots 182, 184, and 186 may be achieved by a variety of mechanisms. In certain embodiments, the keyhole slots 182, 184, and 186 may restrict the lateral/transversal movement of the bossed members 36, 38, and 40 from the narrowed slot portion 190 and into the enlarged slot portion 188, at which point the computer chassis 10 and tower base mount 156 can be separated by an outward/vertical movement. For example, the bossed members 36, 38, and 40 and corresponding keyhole slots 182, 184, and 186 may be structured for a compressive-fit or snap-fit within the narrowed slot portion 190. Alternatively, the tower base mount 156 may include a wide variety of additional tool-based or tool-free retaining mechanisms, such as a snap-fit mechanism, a spring-loaded latch or pin, threaded fasteners, or other suitable couplings. For example, externally threaded fasteners 196 and 198 may be disposed through the tower base mount 156 and into the computer chassis 10 to prevent lateral disengagement of the foregoing bossed members 36, 38, and 40 from the narrowed slot portion 190 of the keyhole slots 182, 184, and 186, respectively. Any other suitable mounting and release mechanisms are also within the scope of the illustrated embodiment.

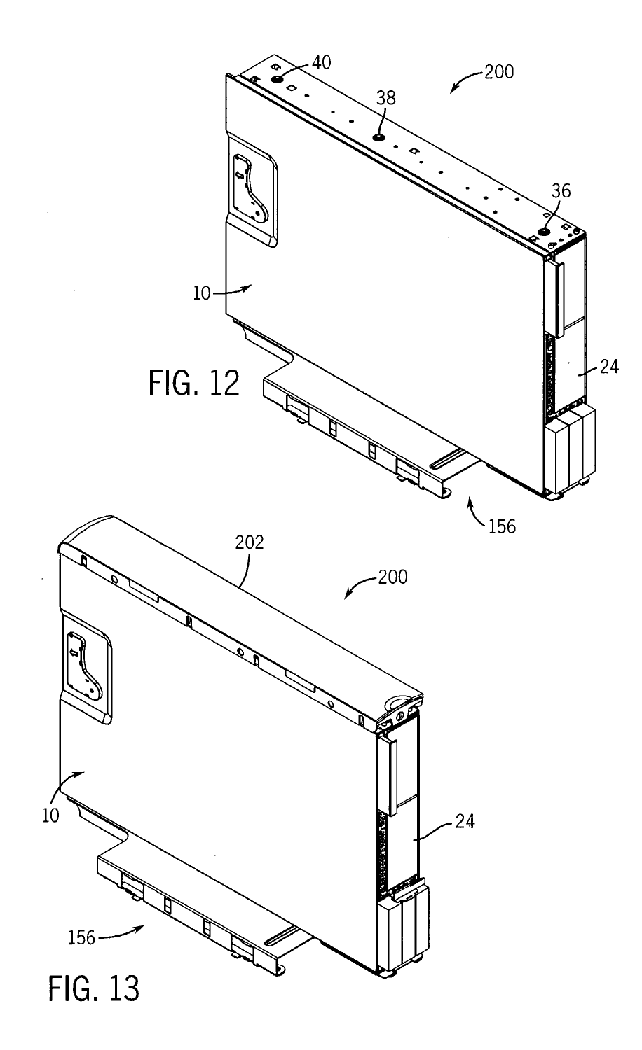

Once assembled with the tower base mount 156, the computer chassis 10 is essentially transformed into a tower mount computer system 200. FIG. 12 is a perspective view illustrating the tower mount computer system 200 incorporating the computer chassis 10 of FIG. 1 and the tower base mount 156 of FIGS. 10-11 in accordance with certain embodiments of the disclosed subject matter. In the illustrated embodiment, the system 200 may have a relatively industrial or rugged configuration suitable for an industrial application, such as a stand-alone server disposed in a secure or inaccessible area. In this industrial configuration, the potential for physical damage and abuse is relatively low, because the computer chassis is disposed within the protective features of the rack structure 92. Additional protective outer casings also may be provided around the rack structure 92. In contrast, as mentioned above, the tower mount computer system 200 may be used in a relatively high traffic area, such as an academic or other publicly accessible setting, where non-technical users may subject the system 200 to significant physical wear and tear. Accordingly, a wide variety of casings and support structures may be disposed about the computer chassis 10 and the tower base mount 156 to adapt the system 200 to a desired application and environmental. For example, casings and structures may be provided to adapt the system 200 to potential food/drink spillage, tampering (e.g., child proof), physical contact (e.g., bumping or hitting), and so forth. These casing and structures also may provide a variety of labels, status indicators, instructions, color coding, and such to make the system 200 more user-friendly or suitable for the intended setting.

As illustrated in FIGS. 13-15, the computer chassis 10 and corresponding tower base mount 156 are encased in a variety of top mounted, side mounted, and front mounted panels or external casings. The features of these panels or casings may be particularly suitable for the desired setting, while also complementing various components of the computer chassis 10 and corresponding tower base mount 156. FIG. 13 is a perspective view illustrating a top cover or structure 202 coupled to the topside of the tower mount computer system of FIG. 12 in accordance with certain embodiments of the disclosed subject matter. Although a wide variety of attachment mechanisms are envisioned, the illustrated top cover or structure 202 can be mounted to the chassis 10 by sliding engagement of keyhole slots (not illustrated) with the bossed members 36, 38, and 40 disposed on the topside of the computer chassis 10 (see FIG. 12). However, any suitable hook, snaps, latches, screws, or generally tool-based or tool-free attachment mechanisms may be used to attach the top cover or structure 202. As illustrated, the top cover or structure 202 provides additional structural support and durability to the computer chassis 10. The structure 202 also may provide various other features, such as tool-based or tool-free mounting mechanisms for other casing members (see FIG. 15).

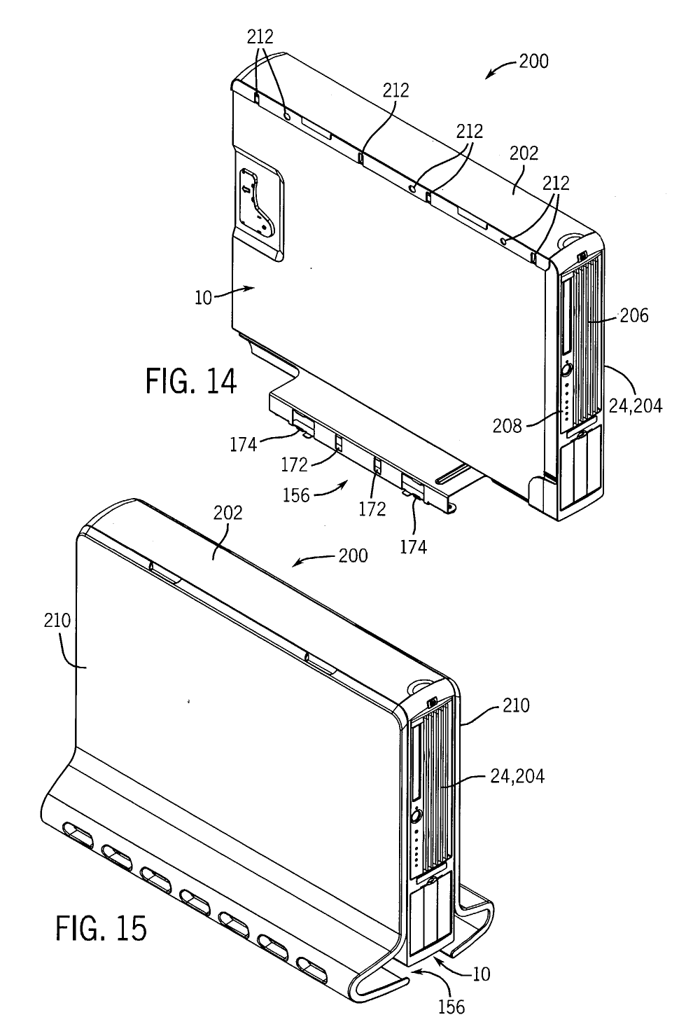

Turning now to the embodiment of FIG. 14, a front cover 204 is coupled to the front 24 of the tower mount computer system 200 of FIGS. 12-13 in accordance with certain embodiments of the disclosed subject matter. As illustrated, the front cover 204 comprises a variety of features and structures, which interact and enhance the internal features of the computer chassis 10. For example, the front cover 204 has a plurality of fan vents 206 (e.g., for directing airflow), a plurality of status indicators 208 (e.g., labels or indication text/symbols for status lights or light emission diodes), and various other desired features. Again, the front cover 204 may be coupled to the computer chassis 10 via a variety of tool-based or tool-free mounting mechanisms, such as snap-fit structures, latches, threaded fasteners, or any other suitable fasteners.

The tower mount computer system 200 also may have one or more lateral panels or structures, such as lateral support structures or covers 210. Among other features, these covers 210 may provide further lateral support and casing durability for the computer chassis 10 and the tower base mount 156. Alternatively, the covers 210 may simply dress up the computer chassis 10 cosmetically for the desired environment, e.g., a home or office environment. FIG. 15 is a perspective view illustrating the lateral support structures 210 disposed about opposite faces of the tower mount computer system 200 of FIGS. 12-14 in accordance with certain embodiments of the disclosed subject matter. As discussed in detail above, these lateral support structures 210 may be mounted to the tower base mount 156 via one or more of the slots 172 and receptacles 174, which may interlock with one or more tool-based or tool-free fasteners on the structures 210 (not illustrated). Additionally, the lateral support structures 210 may be mounted to the topside of the computer chassis 10 via one or more tool-based or tool-free fasteners, such as snap-fit or spring-loaded latches. For example, the lateral support structures 210 of FIG. 15 may be coupled to a variety of male or female latch structures, such as members/receptacles 212 disposed on the top cover 202 (see FIG. 14). Once assembled, the tower mount computer system 200 has a relatively sturdy, cosmetically appealing, and user-friendly configuration for the desired setting and application.

What is claimed is:

1. A transformable computer, comprising:
a computer chassis comprising a mounting latch member; and
a plurality of mounts interchangeably coupleable with the mounting latch member, wherein the plurality of mounts comprise a rail mount for a rack mount computer configuration and a tower base mount for a vertical tower computer configuration.

2. The transformable computer of claim 1, wherein the computer chassis comprises a housing having a form factor of a rack mountable device.

3. The transformable computer of claim 1, wherein the mounting latch member comprises a tool-free coupling member.

4. The transformable computer of claim 3, wherein the tool-free coupling member comprises a bossed member.

5. The transformable computer of claim 4, wherein each of the plurality of mounts comprise a latching slot having narrowed and enlarged portions engageable with the bossed member.

6. The transformable computer of claim 1, wherein the rail mount and the tower base mount each comprise a latching receptacle coupleable with at least one bossed member.

7. The transformable computer of claim 1, further comprising an outer casing structure tool-lessly coupleable to the computer chassis.

8. A system, comprising:
a mounting latch member adapted for positioning on a computer chassis;
a rack mount adapted to mount the computer chassis in a rack mount computer system; and
a tower base mount adapted to mount the computer chassis in a vertical tower configuration, wherein the rack and tower base mounts are interchangeably coupleable with the mounting latch member.

9. The system of claim 8, wherein the mounting latch member comprises a snap-fit mechanism.

10. The system of claim 8, wherein the mounting latch member comprises a slidable interlock mechanism.

11. The system of claim 10, wherein the slidable interlock mechanism comprises at least one of a bossed member and a keyhole slot.

12. The system of claim 8, wherein the rack mount and the tower base mount each comprise a mating latch member coupleable with the mounting latch member.

13. The system of claim 8, wherein the rack mount comprises a pair of rails adapted to mount the computer chassis slidingly to a mating pair of rails disposed in the rack mount computer system.

14. The system of claim 8, further comprising a front mount adapted to retain the computer chassis releasably at a front portion of the rack mount computer system.

15. The system of claim 8, further comprising at least one external support panel adapted for tool-free coupling with the computer chassis.

16. A computer system, comprising:
means for supporting computing components; and
means for interchangeably transforming the means for supporting computing components between rack mount and vertical tower configurations.

17. The computer system of claim 16, wherein the means for supporting computing components comprises a modular casing sized for a modular receptacle in a rack mount computer system.

18. The computer system of claim 16, wherein the means for interchangeably transforming comprise a tool-free coupling mechanism.

19. The computer system of claim 16, wherein the means for interchangeably transforming comprise a tower base mount.

20. The computer system of claim 16, wherein the means for interchangeably transforming comprise a rack mountable rail.

21. The computer system of claim 16, wherein the means for interchangeably transforming comprise a front mount coupled to the means for supporting computing components and releasably coupleable to a rack structure.

22. The computer system of claim 16, wherein the means for interchangeably transforming comprise means for encasing the means for supporting computing components in the vertical tower configuration.

23. A method of using a computer chassis, comprising:
providing a computer chassis; and
interchangeably coupling one of a rack mountable rail and a tower base mount to the computer chassis at least partially with a tool-free coupling member.

24. The method of claim 23, wherein interchangeably coupling comprises engaging a bossed member with a latching receptacle to an interlock position.

25. The method of claim 23, wherein interchangeably coupling comprises transforming the computer chassis between rack mount and vertical tower computer systems.
